(19) United States
(12) Patent Application Publication
(10) Pub. No.: US 2026/0250100 A1
(43) Pub. Date: Aug. 27, 2026

(54) ARRANGEMENT FOR OPERATING AN ELEVATOR

(71) Applicant: KONE Corporation, Helsinki (FI)

(72) Inventors: Ari Jussila, Helsinki (FI); Toni Hirvonen, Helsinki (FI)

(73) Assignee: KONE Corporation, Helsinki (FI)

(21) Appl. No.: 19/459,180

(22) Filed: Jan. 26, 2026

(30) Foreign Application Priority Data
Feb. 26, 2025 (EP) 25160129.0

(51) Int. Cl. B66B 5/02; B66B 1/30; B66B 1/34

(52) U.S. Cl. CPC B66B 5/027; B66B 1/30; B66B 1/3461; B66B 1/3492

(57) ABSTRACT

An arrangement for bringing an elevator car to safety at a faster speed. The arrangement comprises high-speed and slow-speed zones. When the elevator car is located at a slow-speed zone, a standard rescue speed is used. When the elevator is located at a high-speed zone, a faster operating speed is used. The speed zones are indicated inside the elevator shaft in a machine-readable manner.

### DESCRIPTION OF BACKGROUND

The following disclosure relates to elevators and particularly to safety features of an elevator.

Modern buildings typically have elevators for moving people and other physical objects. Elevators comprise a hoisting machine to which elevator cars are connected to the hoisting machine using hoisting ropes, belts or similar. The hoisting ropes run via a traction sheave of the hoisting machine. The hoisting machine moves the connected elevator car and a counterweight so that passengers and transported objects are moved to a desired destination. The elevator car runs in a shaft that has safety buffers in the bottom part of the elevator shaft. The buffers are used to reduce the power of an impact in case that the elevator car or the counterweight for some reason would hit the bottom of the elevator shaft. The buffer for the counterweight may be of different dimensions as the counterweight is smaller in volume and of fixed weight.

The elevator also comprises hoisting machinery brakes. The hoisting machinery brakes can be opened or closed so that the brake reduces the speed of the elevator car. The movement by the hoisting machine and brakes is controlled by a controller that receives commands, for example, from control panels, calling devices or other systems and peripherals that have been connected to the elevator.

During the normal operation elevators may face abnormal situations that without appropriate safety measures could be dangerous to passengers. For this reason, in most countries, the necessary safety measures of elevators are regulated and controlled. It is common that an elevator, in case of emergency or other incidents, elevator is stopped. It is possible that after the stopping signal, the elevator car is located between two floors and the passengers cannot exit the elevator car. Thus, the stopped elevator then needs to be brought into a possible exit floor, such as a rescue floor, dedicated evacuation floor or any other decided floor. This is often done by using a rescue operation mode, in which the elevator is manually driven at a very slow speed to the next floor to unload the elevator car.

### SUMMARY

In the following disclosure arrangement for operating an elevator and particularly bringing an elevator car to safety at a faster speed is disclosed. The arrangement comprises high-speed and slow-speed zones. When the elevator car is located in a slow-speed zone, a standard rescue speed is used. When the elevator is located in a high-speed zone, a faster operating speed is used. The speed zones are indicated inside the elevator shaft in a machine-readable manner.

In an aspect an elevator is disclosed. The elevator comprises an elevator shaft comprising at least one high-speed rescue zone and at least one slow-speed rescue zone each comprising a speed limit; an elevator car in the elevator shaft, wherein the elevator car is connected to a hoisting machine using hoisting ropes; a controller configured to operate the hoisting machine; a rescue controlling device configured to control a rescue drive function of the elevator, wherein the controlling device is located outside of the elevator shaft; wherein the controller is configured to: receive a rescue drive instruction from the rescue controlling device; and operate the hoisting machine according to the received rescue drive instruction, wherein when operating, the controller is further configured to detect if the elevator car is located in a high-speed zone; and accelerate the elevator car to a predetermined maximum speed as a response to the detected location in the high-speed zone. It is beneficial to have an arrangement with two different speed zones so that the elevator can be operated at a higher speed when possible. This facilitates bringing the elevator to safety faster.

In an implementation the controller is configured to accelerate the elevator to a predetermined standard rescue operating speed before the controller detects that the elevator car is in the high-speed zone. It is beneficial to accelerate the elevator to standard rescue operating speed immediately so that it is not necessary to gain knowledge of the speed limit before the rescue operating mode starts.

In an implementation the elevator further comprises a safety controller configured to: monitor the operating speed of the elevator car; and prevent operating speed exceeding the speed limit associated with the current speed zone. It is beneficial to have an independent safety controller that monitors the speed even in cases when the normal controlling means of the elevator are not functioning properly because of a fault or other reason.

In an implementation the elevator shaft further comprises at least one marking indicating a speed zone; and the elevator car comprises at least one reader configured to read the marking indicating a speed zone. It is beneficial to mark the different speed zones in the elevator shaft so that they can be read using a reader device during the rescue operation.

In an implementation the marking is one of the following: a magnet, a radio frequency identification tag, an optical target or a marking tape. It is beneficial to use easy to read markings that can be arranged to the elevator shaft as independent objects or in the form of continuous tape.

In an implementation the location of each speed zone is dependent on the travelling direction of the elevator car. It is beneficial to have speed zones in different locations in the elevator shaft depending on the travelling direction as the operating speeds may be different. This provides a possibility to maximize the length and to optimize the location of the high-speed zone.

In an implementation the speed limit in the high-speed rescue zone is dependent on the travelling direction of the elevator car. It is beneficial to have different speed limits depending on the travelling direction so that the highest possible speed can be used to both directions.

In an implementation the speed limit in the high-speed rescue zone corresponds to a maximum elevator car buffer speed when the elevator car is travelling downwards. It is beneficial to set the speed limit according to the respective buffer so that the highest possible speed can be used both directions.

In an implementation the speed limit in the high-speed rescue zone corresponds to a maximum counterweight buffer speed when the elevator car is travelling upwards. It is beneficial to set the speed limit according to the respective buffer so that the highest possible speed can be used in both directions.

In an implementation the elevator further comprises a position sensor configured to indicate the position of the elevator car in the elevator shaft for determining the speed zone. It is beneficial to use a position sensor in addition to the markings so that the elevator may determine the speed limit also based on the location of the elevator car.

In an implementation the elevator shaft further comprises at least one deceleration zone. It is beneficial to have a separate indicator for deceleration so that the elevator car can be decelerated before the speed limit changes and the speed limit is not exceeded at any location.

In an implementation at least one of the speed zones comprises at least one temporarily set parameter. It is beneficial to have parameters that can be set temporarily so that the overall speed of bringing the elevator car into safety may be improved.

In an aspect a method of operating an elevator is disclosed. The method of operating an elevator comprises receiving a rescue drive instruction from the rescue controlling device; operating the hoisting machine according to the received rescue drive instruction, wherein when operating: detecting if the elevator car is located in a high-speed zone; and accelerating the elevator car to a predetermined maximum speed as a response to the detected location in the high-speed zone. It is beneficial to have two different speed zones so that the elevator can be operated at a higher speed when possible. This facilitates bringing the elevator to safety faster.

In an implementation the method further comprises accelerating the elevator to a predetermined standard rescue operating speed before the controller detects that the elevator car is in the high-speed zone. It is beneficial to accelerate the elevator to standard rescue operating speed immediately so that it is not necessary to gain knowledge of the speed limit before the rescue operating mode starts.

In an implementation the method further comprises: reading a marking indicating a speed zone. It is beneficial to mark the different speed zones in the elevator shaft so that they can be read using a reader device during the rescue operation.

The aspects and example implementations described in the above provide a possibility to bring the elevator car into safety faster and more efficiently. In case of an emergency where the speed is needed this may be crucial. Furthermore, in cases where the passengers are not in danger the faster rescue time will improve convenience and particularly reduce the inconvenience of persons that are afraid of exceptional events and particularly in elevators.

### BRIEF DESCRIPTION OF THE DRAWINGS

The accompanying drawings, which are included to provide a further understanding of the arrangement for operating an elevator and constitute a part of this specification, illustrate embodiments and together with the description help to explain the principles of the arrangement for operating an elevator. In the drawings:

FIG. 1 is a block diagram of an example embodiment of the arrangement for operating an elevator,

FIG. 2 is a flow chart of an example of a method of operating an elevator,

FIG. 3 is a flow chart of an example of a method of operating an elevator, and

FIG. 4 is a flow chart of an example of a method of operating an elevator.

### DETAILED DESCRIPTION

Reference will now be made in detail to the embodiments, examples of which are illustrated in the accompanying drawings.

In the following disclosure the expression rescue operation mode is referred to mean a special operation mode of an elevator, wherein the elevator is brough back into an exit floor after an unintentional stop. The unintentional stop occurs in a location between possible exit floors and the elevator car needs to be moved upwards or downwards to the next possible exit floor for unloading the elevator car. The rescue operating mode is commonly regulated by authorities and a standard operating speed may be determined by this regulation. The rescue operating mode is controlled by a controlling device located outside the elevator shaft as it is not intended to be used by ordinary passengers of the elevator but maintenance or surveillance staff. The rescue controlling device, or any other device used to control rescue operating mode, may be an independent special purpose device located at the elevator, or it may also be incorporated into other controlling apparatuses of the elevator. It is possible that one elevator comprises one or more controlling devices that may be accessed from different locations outside of the elevator shaft.

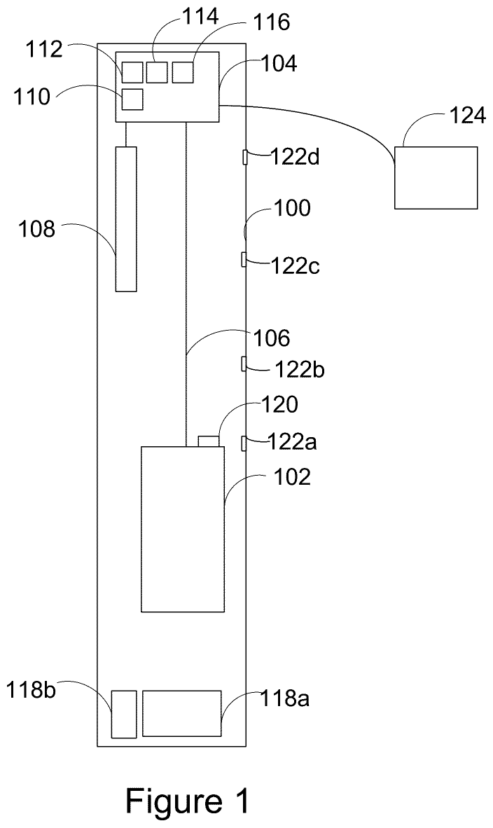

In FIG. 1 a block diagram of an example embodiment of the arrangement for operating an elevator is disclosed. In the figure an example of an elevator is shown. In the example of FIG. 1 only one elevator is shown, however, particularly in high rise buildings there are typically a plurality of elevators in an elevator group and some of the services may be shared with other elevators. Services and devices that are shared within an elevator group are configured in a manner that they may be used, if needed, for providing instructions to individual elevators also in a manner that does not require interaction with other elevators in the group. For example, elevator journeys may be scheduled using the knowledge of other elevators and scheduled calls and journeys so that the throughput of the elevator system is maximized. The elevator of the example comprises an elevator shaft 100, wherein an elevator car 102 runs up and down. The elevator car 102 is connected to a hoisting arrangement 104 using one or more ropes 106. The ropes are also connected to a counterweight 108. The counterweight runs in the opposite direction with the elevator car. The ropes are arranged to run through one or more sheaves.

The hoisting arrangement 104 is illustrated here in the top of the shaft 100, however, this is only for illustrative reasons. The hoisting machine and other components illustrated in the figure may be located in different locations, which depending on the component, may be located in the shaft or outside the shaft. In very traditional elevators the hoisting machine and a machine room were located on the top of the shaft 100, however, in modern elevators separate machine rooms are not always needed and hoisting may be arranged also from the bottom of the shaft by arranging the ropes appropriately. The design of an elevator is highly dependent on the building. For example, tall buildings may have separate express elevators that do not or even cannot stop on every floor.

The example of FIG. 1 comprises two safety buffers 118a, 118b in the bottom of the shaft that are provided separately for the elevator car 102 and the counterweight 108. The buffers are designed to reduce the impact in case of unintentional crash of the elevator car against the bottom of the elevator shaft. The maximum allowed speed for a safe impact can be determined when the size and weight of the elevator car and the counterweight are known. Using the maximum allowed speed, or a lower speed, when operating elevator near the elevator shaft end, facilitates safe stopping even in case of the rare event that the elevator does not stop at the bottom floor but travels further to the elevator shaft pit, or similarly, travels above the top floor.

In the example of FIG. 1 the hoisting arrangement 104 comprises additionally a controller 110 and a position measurement sensor 112. The position measurement sensor 112 is an optional component and may be used in some embodiments discussed below. The position sensor may be useful particularly when also other elevator functions use the information provided by the position sensor. The controller of FIG. 1 is configured to control all movements of the elevator. It is possible that the controller controls also other things, such as lighting and door opening. The controller is configured to receive information from elevator peripherals and processes the received information so that the passengers can be brought to their destination. In FIG. 1 the position measurement sensor 112 may be used, for example, in position dependent travelling speed management and overspeed governing. The position measurement sensor needs not to be of any specific type, however, it needs to be configured to indicate the position of the elevator car in the elevator shaft. The elevator comprises also an electronic overspeed governor that 114 that is used for preventing the elevator car travelling too fast. The overspeed governor may be used in ordinary operating mode or in special operating modes, such as a rescue operation mode. This may be achieved, for example, by setting a speed limit according to the desired maximum speed. The overspeed governor is typically an independent device so that it is not controlled by the controller 110 that is controlling common functionality of the elevator. This is because it is desired to have an independent overspeed governor that will be operable also in the case, wherein the controller fails somehow. The overspeed governor used in the present arrangement for operating an elevator may be implemented using information received from the electronic overspeed governor 114 that can send instructions to controller 110, or other similar controller controlling the operating speed of the elevator car. In an alternative embodiment the overspeed governor does not need to communicate with the controller controlling the common functionality.

As explained in the above, the elevator comprises a position measurement sensor 112. The position measurement sensor 112 is configured to indicate the position of the elevator car 102 in the elevator shaft 100. The position measurement sensor can be implemented in several ways. For example, the sensor may be electro-mechanical sensor or optical sensor. The shaft may be designed so that the counterweight hits buffers 118b before the elevator car hits the top of the shaft. The buffers have a maximum impact speed, however, when the elevator car is far away from the buffers, it is possible to allow faster speed for the elevator car 102. In the event of a possible emergency, the speed of the elevator car 102 can be reduced using the hoisting machine 104 or by using a braking mechanism before the elevator car 102 hits the buffers 118a. This is particularly beneficial in high buildings, wherein faster elevator speeds are desired. The variable speed limit facilitates driving elevators faster when they are not near a shaft end.

In the example of FIG. 1 the elevator further comprises a reader device 120. In the example of FIG. 1 the reading device is arranged on the top of the elevator car 102, however, this is not necessary. The reader device 120 may be arranged to any location on the elevator car 102 provided that it is capable of reading markings attached to the elevator shaft 100. In the example of FIG. 1 marking 122a-122d are shown as examples of such markings. Markings 122a-122d may be any marking objects that can be configured to contain information with regard operation parameters of an elevator. An example of such an operation parameter is a speed limit for rescue operation mode. The marking or marking object may be a magnetic tag, radio frequency tag, optic sign or similar. In the example of FIG. 1 four separate marking objects 122a-122d are shown, however, the markings may be arranged in form of a continuous tape or in any other suitable form. The reader device 120 is a reader device suitable for reading the selected marking object. In the case of an optical marking object, it is possible to use a camera or other optical sensing device. In case of magnetic or radio frequency marking object, a magnetic or radio frequency reader device is used.

The example of FIG. 1 further comprises a safety controller 116 and rescue drive controlling device 124. In the example of FIG. 1 the safety controller 116 is configured to control all safety related features. Safety related features are often regulated and may require redundancy by using two independent controllers or similar safety arrangements. In the present example the safety controller 116 comprises all necessary components.

In the example of FIG. 1 four markings 122a-122d are shown. These markings may have different content. For example, if the elevator car of FIG. 1 is travelling upwards, the reader device 120 first reads marking 122a. The marking 122a may indicate that the elevator car in a high-speed section. Thus, the elevator car may be accelerated to the maximum speed. Next the elevator car will pass marking 122b, which may indicate that the elevator car is still in the high-speed section so that the speed does not need to be changed. Marking 122c may indicate that a deceleration section initiates from marking 122c. In the example of FIG. 1 this means that the speed of the elevator car may still be higher than the lower standard speed, however, the speed should be decelerated. In the example of FIG. 1 the marking 122d indicates a low-speed zone, wherein it is allowed to use only the lower standard speed.

In the example described above there is a separate deceleration indicator, however, it is not necessary. It is possible to use only two types of markings indicating lower or higher speed limit. When the controller or safety controller of the elevator detects that the elevator car is running above the current speed limit, it will reduce the speed to match with the speed limit. The elevator may be configured to use a predetermined deceleration speed after detecting that the elevator car is located in a low-speed zone. The deceleration speed may be chosen for each implementation separately.

The speed limits discussed above are associated with rescue operation mode. Thus, both of them are typically lower than ordinary operation speed limits. For example, the lower speed-limit may be set according to the regulations and is often 0.3 m/s. However, a faster speed may be used if the design of the elevator allows it. The speed limit for the high-speed zone may be set according to the buffer impact speed. The speed limit may not exceed the maximum buffer impact speed, i.e., the speed that is considered to be the highest safe speed to hit the buffers. The maximum speed impact may be inconvenient, so also lower speed may be used.

The speed limit may be dependent on the driving direction. The elevator car and the counterweight may have different safety buffers and thus, the maximum buffer impact speed may depend on the buffer that is hit. The buffers may be different as the full elevator car typically weighs more than the counterweight and the empty elevator car weighs less than the counterweight. Thus, the maximum impact speed may be different for different buffers. However, the same principle applies to both directions. The speed limit should not exceed the maximum buffer impact speed. When the elevator car is going upwards, the relevant maximum buffer impact speed is typically the maximum buffer impact speed of the counterweight. When the elevator car is going downwards, the relevant maximum buffer impact speed is typically the maximum buffer impact speed of the elevator car.

In some implementations the elevator is configured to use the reader continuously so that the elevator is aware of the rescue operating mode speed limit all the time and also in the normal operating mode. Thus, if the rescue operating mode is needed, the elevator knows whether the elevator car is located in a low-speed or high-speed zone. In addition to reading the markings it may be possible to determine the speed limit using other means. For example, if the elevator has a position sensor, it is possible to determine the speed zones using the position sensor. Accordingly, if the elevator car has started the journey from one of the elevator shaft end, it is possible to determine that the higher speed may be used. The additional means that facilitate higher speed from the beginning of the rescue operation mode are optional. Thus, it is possible to determine that the elevator car cannot exceed the standard rescue speed before the reader has successfully read the first marking indicating the current speed zone. If a deceleration marking is read as a first marking, the rescue operating speed can be maintained.

In some implementations the elevator comprises a safety controller that is configured to monitor the operating speed of the elevator. The safety controller, or other controller device, continuously reads or measures the operating speed of the elevator. The safety controller is configured to know if the elevator is operated in normal operating mode or rescue operating mode. Both of the operating modes, as well as other possible operating modes, may have one or more speed limits. The safety controller is configured to determine the current speed limit. This may be done by retrieving from another controller or by taking the operating mode and the current location of the elevator car into account. When the safety controller detects that the elevator car is running too fast, the safety controller will send a signal instructing to decelerate the speed by using hoisting machine and/or brakes.

The examples discussed above may contain temporarily set parameters. The temporary setting may comprise any parameters relating to the rescue operation. For example, it is possible temporarily prevent a driving direction or use of the closest possible exit floor. Also the speed limits and the locations of slow-speed and high-speed zones may be changed temporarily.

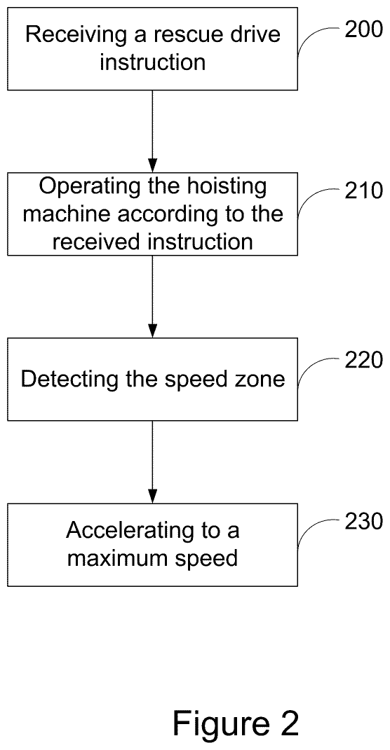

FIG. 2 discloses an example of a method of operating an elevator. The method is initiated by receiving a rescue drive instruction, step 200. The instruction may be received from, for example, a rescue controlling device that is operated by a person. The operating may be arranged so that the person using the rescue controlling device pushes two buttons simultaneously and while both buttons are pushed the elevator car moves. The rescue controlling device may comprise separate buttons for both driving directions or there may be a direction selector and only after that the buttons are pressed. Instead of buttons also different suitable controls that are operated two at time may be used. This means that the operator of the device may need to use both hands in order to move the elevator car. In another implementation the rescue operating mode is controllable from a remote device or monitoring center, if the local regulation allows a remote control.

The elevator controller operates a hoisting machine of the elevator according to the received instruction, step 210. There may be components between the rescue controlling device and the hoisting machine. Thus, the rescue controlling device may be directly connected to the hoisting machine, however, it is not necessary and the instructions may be processed by one or more other components, such as a controller controlling normal operation of the elevator.

In the example of FIG. 2 the elevator first detects the current speed zone, step 220. This may be done by several different ways. For example, the elevator may monitor the speed zones also during the normal operating mode and thus, it is aware of the rescue operating mode speed limits all the time even if rescue operating mode is needed very seldom. In another option it is possible that the elevator is located in a position, for example, close to an end of the elevator shaft and travelling in different direction, so that the speed limit can be determined from the location. Another option is to move the elevator very slowly before the first marking indicating the speed limit is read.

Finally, the elevator car is accelerated to the current maximum speed according to the read speed limit, step 230. The current maximum speed read using the reader may be a standard rescue operating speed, maximum buffer impact speed or any other speed below the maximum buffer impact speed.

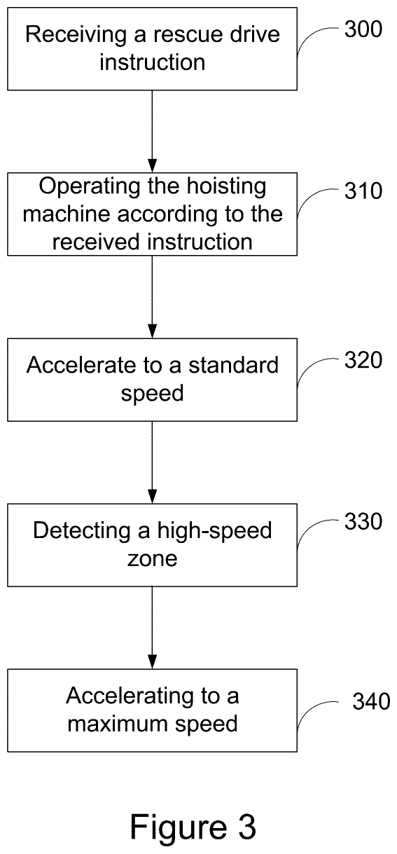

In the example of FIG. 3 another method for operating an elevator is disclosed. In the example of FIG. 3 an instruction for rescue drive is received, step 300. The instruction may be received from a separate rescue controlling device or any other suitable controlling device.

After receiving the instruction for rescue drive the hoisting machine is operated according to the received rescue driving instruction, step 310. As a response to the received rescue driving instruction the elevator car is accelerated to a standard rescue speed, step 320. Thus, the example of FIG. 3 does not require any additional information for determining what is the speed limit but the standard rescue speed is assumed as the speed limit.

The elevator car then moves in the elevator shaft at the standard rescue speed. During that time a reader device at the elevator car reads markings in the elevator shaft. The markings may be separate object spaced apart or be in a continuous form. When the reader device detects a marking indicating a high-speed zone, step 330, the elevator car is accelerated to the maximum speed of the high-speed zone, step 340. The maximum speed, in this case, corresponds with or is based on the maximum impact speed of the relevant buffers. As explained in the above, the maximum impact speed may be dependent on the driving direction.

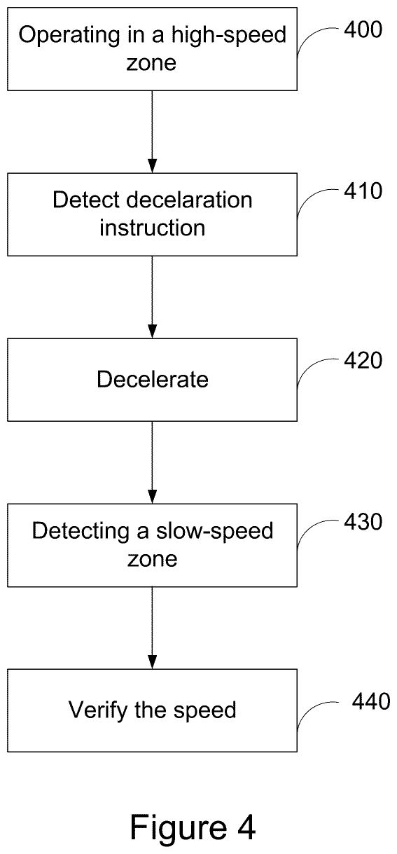

In the example of FIG. 4 another method for operating an elevator is disclosed. In the example of FIG. 4 the elevator car is travelling in a high-speed zone at the maximum speed, step 400. The elevator car reads markings in the elevator shaft continuously and detects an instruction to decelerate, step 410. The instruction to decelerate may include information with regard to the final speed after deceleration and optionally also the deceleration speed. The hoisting machine then decelerates the elevator car, step 420, by reducing the operating speed or using a braking system. After deceleration the reader device reads a marking indicating a low-speed zone, step 430. The elevator should now be operated at the low speed, typically 0.3 m/s. The elevator verifies that the lower speed limit is observed, step 440. If the verification indicates that the elevator is travelling faster, any of suitable systems, such as the hoisting machine, a controller of the hoisting machine, a safety controller or alike, may decelerate the elevator car further so that the speed limit is observed.

In the above examples of methods and required arrangements have been discussed. The person skilled in the art understands that these are only examples and is able to implement the arrangement also in various other ways provided that the elevator uses speed limit aware rescue operating mode with a low-speed zone and high-speed zone.

As stated above, the components of the exemplary implementations can include computer readable medium or memories for holding instructions programmed according to the teachings of the present inventions and for holding data structures, tables, records, and/or other data described herein. Computer readable medium can include any suitable medium that participates in providing instructions to a processor for execution. Common forms of computer-readable media can include, for example, a floppy disk, hard disk, magnetic tape, any other suitable magnetic medium, a CD-ROM, DVD, Blu-ray Disc, any other suitable optical medium, a RAM, a PROM, an EPROM, a FLASH-EPROM, any other suitable memory chip or cartridge, a carrier wave or any other suitable medium from which a computer can read.

It is obvious to a person skilled in the art that with the advancement of technology, the basic idea of the arrangement for operating an elevator may be implemented in various ways. The arrangement for operating an elevator and its implementations are thus not limited to the examples described above; instead they may vary within the scope of the claims.

1. An elevator comprising:
an elevator shaft comprising at least one high-speed rescue zone and at least one slow-speed rescue zone each comprising a speed limit;
an elevator car in the elevator shaft, wherein the elevator car is connected to a hoisting machine using hoisting ropes;
a controller configured to operate the hoisting machine;
a rescue controlling device configured to control a rescue drive function of the elevator, wherein the controlling device is located outside of the elevator shaft;
wherein the controller is configured to:
receive a rescue drive instruction from the rescue controlling device; and
operate the hoisting machine according to the received rescue drive instruction, wherein when operating, the controller is further configured to detect if the elevator car is located in a high-speed zone; and
accelerate the elevator car to a predetermined maximum speed as a response to the detected location in the high-speed zone.

2. An elevator according to claim 1, wherein the controller is configured to accelerate the elevator to a predetermined standard rescue operating speed before the controller detects that the elevator car is in the high-speed zone.

3. An elevator according to claim 1, wherein the elevator further comprises a safety controller configured to:
monitor the operating speed of the elevator car; and
prevent operating speed exceeding the speed limit associated with the current speed zone.

4. An elevator according to claim 1, wherein:
the elevator shaft further comprises at least one marking indicating a speed zone; and
the elevator car comprises at least one reader configured to read the marking indicating a speed zone.

5. An elevator according to claim 4, wherein the marking is one of the following: a magnet, a radio frequency identification tag, an optical target or a marking tape.

6. An elevator according to claim 1, wherein the location of each speed zone is dependent on the travelling direction of the elevator car.

7. An elevator according to claim 1, wherein the speed limit in the high-speed rescue zone is dependent on the travelling direction of the elevator car.

8. An elevator according to claim 1, wherein the speed limit in the high-speed rescue zone corresponds to a maximum elevator car buffer speed when the elevator car is travelling downwards.

9. An elevator according to claim 1, wherein the speed limit in the high-speed rescue zone corresponds to a maximum counterweight buffer speed when the elevator car is travelling upwards.

10. An elevator according to claim 1, wherein the elevator further comprises a position sensor configured to indicate the position of the elevator car in the elevator shaft for determining the speed zone.

11. An elevator according to claim 1, wherein the elevator shaft further comprises at least one deceleration zone.

12. An elevator according to claim 1, wherein at least one of the speed zones comprises at least one temporarily set parameter.

13. A method of operating an elevator comprising:
receiving a rescue drive instruction from the rescue controlling device;
operating the hoisting machine according to the received rescue drive instruction, wherein when operating:
detecting if the elevator car is located in a high-speed zone; and
accelerating the elevator car to a predetermined maximum speed as a response to the detected location in the high-speed zone.

14. A method according to claim 13, wherein the method further comprises:
accelerating the elevator to a predetermined standard rescue operating speed before the controller detects that the elevator car is in the high-speed zone.

15. A method according to claim 13, wherein the method further comprises:
reading a marking indicating a speed zone.

16. An elevator according to claim 2, wherein the elevator further comprises a safety controller configured to:
monitor the operating speed of the elevator car; and
prevent operating speed exceeding the speed limit associated with the current speed zone.

17. An elevator according to claim 2, wherein:
the elevator shaft further comprises at least one marking indicating a speed zone; and
the elevator car comprises at least one reader configured to read the marking indicating a speed zone.

18. An elevator according to claim 3, wherein:
the elevator shaft further comprises at least one marking indicating a speed zone; and
the elevator car comprises at least one reader configured to read the marking indicating a speed zone.

19. An elevator according to claim 2, wherein the location of each speed zone is dependent on the travelling direction of the elevator car.

20. An elevator according to claim 3, wherein the location of each speed zone is dependent on the travelling direction of the elevator car.
